(19) United States
(12) Patent Application Publication
(10) Pub. No.: US 2013/0057179 A1
(43) Pub. Date: Mar. 7, 2013

(54) Circuit and Method for Operating a Lighting Unit and a Luminaire Having a Circuit of this kind

(71) Applicant: Bernd Rudolph, Forstern (DE)

(72) Inventor: Bernd Rudolph, Forstern (DE)

(21) Appl. No.: 13/697,788

(22) PCT Filed: Mar. 21, 2011
(86) PCT No.: PCT/EP2011/054196

§ 371 Date: Nov. 13, 2012

(30) Foreign Application Priority Data
May 10, 2010 (DE) 10 2010 028 804.7

(51) Int. Cl. H05B 37/02

(52) U.S. Cl. 315/297

(57) ABSTRACT

A circuit for actuating a lighting unit comprising: (120) a current mirror (T1, T2) which can be biased with a reference voltage source (D1); a hysteresis circuit (130) which is connected to the output of the current mirror (T1, T2); and a step-down converter (T3, D2, L1) with an electronic switch (T3), the electronic switch (T3) being connected to the output of the hysteresis circuit (130); wherein the lighting unit (120) can be actuated by the step-down converter (T3).

The invention relates to a circuit and a method for operating a lighting unit and a luminaire having a circuit of this kind.

Semiconductor lighting elements, in particular light emitting diodes (LEDs), are increasingly also employed for general lighting. For operating such types of lighting elements power supply circuits are required which are simple, favorably priced and effective.

WO 2009/089912 shows a step-down converter which is operated in a so-called “continuous” mode, in other words the principal energy storage element (inductance) of the converter is not completely demagnetized in each switching cycle. Even without additional energy storage (capacitor), the current through the load (light emitting diode) varies between a maximum and a minimum value which is greater than zero. The disadvantage of this solution consists in the fact that a voltage of approx. 0.6 V in total drops out at the two shunt resistances used. This impairs the efficiency of the circuit.

The object of the invention consists in avoiding the previously mentioned disadvantages and in particular specifying an improved circuit for operating at least one semiconductor lighting element.

This object is achieved in accordance with the features of the independent claims. Developments of the invention are also set down in the dependent claims.

In order to achieve the object, a circuit for actuating a lighting unit is specified,
comprising a current mirror which can be biased by means of a reference voltage source;
comprising a hysteresis circuit which is connected to the output of the current mirror;
comprising a step-down converter with an electronic switch, the electronic switch being connected to the output of the hysteresis circuit;
wherein the lighting unit can be actuated by means of the step-down converter.

The electronic switch is for example a transistor, in particular a field-effect transistor or MOSFET.

A current from an energy source to the lighting unit can be set by means of the electronic switch. In particular, the step-down converter can be operated in a continuous mode.

The proposed solution has the advantage that the electrical energy stored in a battery can be utilized efficiently and a practically uniform brightness of the lighting unit is ensured for as long as possible.

One development is that the current mirror is connected on the input side by way of a first current sensing resistor and on the output side by way of a second current sensing resistor to a supply voltage.

By preference, the current sensing resistors are dimensioned to be small, for example less than 1 Ohm, such that only a slight voltage drops out at said current sensing resistors.

It is a further development that switching thresholds of the electronic switch of the step-down converter can be set by means of the first current sensing resistor and the second current sensing resistor.

In particular, it is a development that the current mirror has two bipolar transistors, the bipolar transistors being connected to one another by way of their base terminals.

It is also a development that
the one bipolar transistor of the current mirror is arranged in a common-base configuration, it being possible to couple the current detectable by the current sensing resistor to the emitter of this bipolar transistor,
wherein the other bipolar transistor of the current mirror can be controlled through the base potential and also by way of the emitter potential, said bipolar transistor being connected to the hysteresis circuit by way of its collector.

It is furthermore a development that the lighting unit comprises at least one semiconductor lighting element.

It is also a development that the circuit comprises an energy source for operating the lighting unit.

The energy source can comprise at least one (rechargeable) battery.

In the context of an additional development, the reference voltage source provides a reference voltage which can be generated by an energy source.

A next development consists in the fact that a diode, a zener diode or a bandgap reference is provided for setting the reference voltage.

One embodiment, is that the current mirror has two pnp transistors.

An alternative embodiment consists in the fact that the hysteresis circuit comprises at least one Schmitt trigger.

A next embodiment is that the hysteresis circuit comprises at least one buffer.

The buffer in question is preferably a power buffer for switching the electronic switch of the step-down.

The aforesaid object is also achieved by a method for operating the circuit described here.

The aforesaid object is furthermore achieved by means of a luminaire comprising the circuit described here.

The luminaire in question can be a hand lamp or a pocket lamp.

Exemplary embodiments of the invention will be illustrated and explained below with reference to the drawing.

In the drawing:

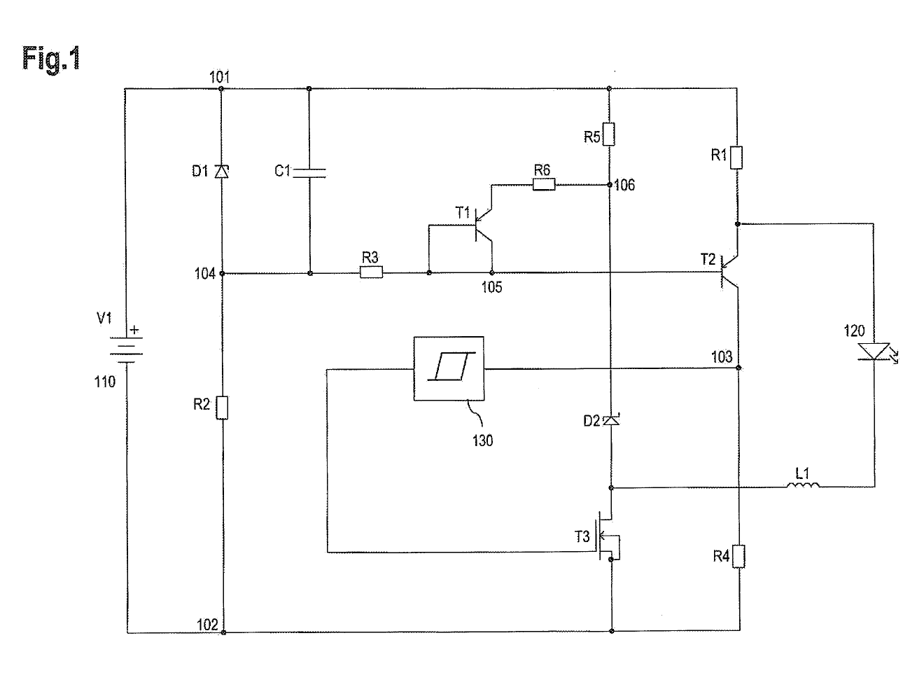

FIG. 1 shows a circuit for operating at least one semiconductor lighting element by means of an energy source, for example a battery, by way of a hysteresis circuit and also a step-down converter.

FIG. 1 shows a circuit for operating at least one semiconductor lighting element 120 by means of an energy source, for example a battery 110, which provides a supply voltage V1.

The positive pole of the battery 110 is connected to a node 101 and the negative pole of the battery 110 is connected to a node 102. The cathode of a diode D1 is connected to the node 101 and the anode of the diode D1 is connected to a node 104. A resistor R2 is arranged between the nodes 104 and 102. A capacitor C1 is arranged parallel to the diode D1. The node 104 is connected to a node 105 by way of a resistor R3. The base and the collector of a pnp transistor T1 and the base of a pnp transistor T2 are connected to the node 105. The emitter of the transistor T1 is connected by way of a resistor R6 to a node 106. A resistor R5 is arranged between the node 101 and the node 106. The cathode of a diode D2 is connected to the node 106 and the anode of the diode D2 is connected to the drain terminal of an n-channel MOSFET T3. The source terminal of the MOSFET T3 is connected to the node 102.

The emitter of the transistor T2 is connected by way of a resistor R1 to the node 101. Furthermore, the emitter of the transistor T2 is connected to the anode of the semiconductor lighting element 120. The cathode of the semiconductor lighting element 120 is connected by way of a coil L1 to the drain terminal of the MOSFET T3.

The collector of the transistor T2 is connected to a node 103 and the node 103 is connected by way of a resistor R4 to the node 102. Furthermore, the node 103 is connected by way of a hysteresis circuit 130 to the gate terminal of the MOSFET T3.

The hysteresis circuit 130 in question can for example be a Schmitt trigger or a comparable component. For example, the hysteresis circuit can be implemented by means of a series circuit of two Schmitt triggers of a CMOS 40106 circuit.

The diode D1 is implemented as a zener diode and the diode D2 is implemented as a Schottky diode.

The components shown in FIG. 1 could be chosen or dimensioned as follows: R1=0.9Ω; R2=330Ω; R3=2.2 kΩ; R4=3.3 kΩ; R5=0.75Ω; R6=220Ω; C1=100 nF; L1=150 μH; T1=T2=SMBT3906; T3=NDS351AN; D1=BZV55C4V3; D2=SS14.

The energy source 110 in question can be at least one battery or at least one accumulator. The circuit shown can be used in a luminaire, for example a hand lamp, pocket lamp or similar. The supply voltage V1 of the energy source is greater than the operating voltage of the semiconductor lighting element 120. A step-down converter comprising the electronic switch T3, the diode D2 and the coil L1 enables an adjustment of the supply voltage V1 provided by the energy source (battery) 110 to the operating voltage of the semiconductor lighting element 120.

Mode of operation of the circuit according to FIG. 1:

The transistors T1 and T2 are arranged as a current mirror. The current mirror is biased by means of a reference voltage by way of the zener diode D1. Connected downstream of the current mirror is a buffer having Schmitt trigger characteristics (cf. hysteresis circuit 130).

The circuit shown in FIG. 1 lowers the switching thresholds for switching the main switch (MOSFET T3) of the step-down converter on and off in the so-called continuous mode considerably below 0.6V (for example to 0.2V) and thereby reduces the losses in the two current sensing resistors R1 and R5.

As a result of the hysteresis circuit 130 which is connected downstream comprising the (integrated) buffer, the MOSFET T3 can be operated as a main switch, and according to requirements a relatively wide operating voltage range (for example from 3V to 18V; the hysteresis circuit 130 is implemented for example using standard CMOS technology) or a miniaturization of the circuit for operation at high frequencies (for example greater than 100 kHz, the hysteresis circuit 130 is implemented in this case as a high-speed CMOS buffer) can be realized.

As a result of the free choice of the reference voltage it is possible to set the control characteristic of the current within wide ranges through the (at least one) semiconductor lighting element 120 as a function of the reference voltage.

The potential at the node 105 is determined largely by way of the zener diode D1 (having for example a breakdown voltage at a level of 4.3V). The transistor T1 is accordingly biased.

If the transistor T2 is conducting, the current then flows by way of the resistor R4. Approximately the supply voltage V1 is applied at the node 103. The supply voltage V1 is also applied at the MOSFET T3 (by way of the Schmitt trigger of the hysteresis circuit 130) and the MOSFET T3 is turned on. With the MOSFET T3 turned on, a current begins to flow by way of the source-drain path of the MOSFET T3, the coil L1, the semiconductor lighting element 120 and the resistor R1. This corresponds to a rising edge of a current signal approximately triangular in shape.

The current continues to flow until the emitter of the transistor T2 is addressed, in other words the transistor T2 gradually locks; the voltage at the resistor R4 drops, which means that the voltage also drops at the node 103 and thus at the hysteresis circuit 130. As soon as a lower switching threshold of the hysteresis circuit 130 is reached or is undershot, the hysteresis circuit 130 switches over and the MOSFET T3 locks. A trailing edge of the current signal approximately triangular in shape begins from this point.

In the freewheeling phase (in other words when the MOSFET T3 is locking) the energy stored in the coil L1 is delivered by way of the diode D2. A current flows by way of the resistor R5 and allows the potential at the emitter of the transistor T1 to fall with respect to ground (here: the potential at the node 102). The potential at the base of the transistor T2 drops and the transistor T2 begins to conduct. The potential at the emitter of the transistor T2 becomes increasingly more positive. If the voltage at the resistor R4 reaches the positive switching threshold of the hysteresis circuit 130, the MOSFET T3 will then be switched to conduct again.

It should be noted here that the resistor R5 is provided in order to enable the transistor T2 to become conducting again. The maximum and also the minimum current thresholds can be set by way of the resistors R1, R5 and R6 in conjunction with the switching thresholds of the hysteresis circuit 130.

Further advantages:

The solution presented makes possible a circuit having low losses in the two resistors R1 and R5.

With this circuit it is possible to achieve a very good current stability for the semiconductor lighting element with a minimum voltage drop, in other words down to very low battery voltages. This means that the battery is used efficiently whilst an almost constant brightness of the semiconductor lighting element is ensured for as long as possible.

As a result of the pulse shaping by means of the hysteresis circuit 130, the circuit enables higher switching frequencies, in particular high-speed CMOS components can for example be employed as Schmitt triggers. As a result of the higher switching frequencies, the size of the coil L1 can be reduced, which means that the overall size of the circuit can be reduced.

In the present situation by way of example, the zener diode D1 having a breakdown voltage of 4.3V is used as the reference voltage source for the current mirror comprising the transistors T1 and T2. Alternatively, it is possible to generate the reference voltage by means of a so-called bandgap (integrated circuit having a predefinable constant voltage).

### LIST OF REFERENCE CHARACTERS

101-106 Node
110 Energy source, for example (rechargeable) battery
120 Semiconductor lighting element
130 Hysteresis circuit
V1 Supply voltage
Ti Electronic switch
Di Diode
Ri Resistor
C1 Capacitor
L1 Coil

1. A circuit for actuating a lighting unit comprising:
a current mirror which can be biased with a reference voltage source;
a hysteresis circuit which is connected to the output of the current mirror; and
a step-down converter with an electronic switch, the electronic switch being connected to the output of the hysteresis circuit;
wherein the lighting unit is adapted to be actuated by the step-down converter.

2. The circuit as claimed in claim 1, wherein the current mirror is connected on the input side by way of a first current sensing resistor and on the output side by way of a second current sensing resistor to a supply voltage.

3. The circuit as claimed in claim 2, wherein switching thresholds of the electronic switch of the step-down converter can be set by means of the first current sensing resistor and the second current sensing resistor.

4. The circuit as claimed in claim 2, wherein the current mirror has two bipolar transistors, the bipolar transistors being connected to one another by way of their base terminals.

5. The circuit as claimed in claim 4,
wherein the one bipolar transistor of the current mirror is arranged in a common-base configuration so as to couple the current detectable by the current sensing resistor to the emitter of this bipolar transistor,
wherein the other bipolar transistor of the current mirror can be controlled through the base potential and also by way of the emitter potential, said bipolar transistor being connected to the hysteresis circuit by way of its collector.

6. The circuit as claimed in claim 1, wherein the lighting unit comprises at least one semiconductor lighting element.

7. The circuit as claimed in claim 1, comprising an energy source for operating the lighting unit.

8. The circuit as claimed in claim 7, wherein the reference voltage source provides a reference voltage which can be generated by the energy source.

9. The circuit as claimed in claim 8, wherein a diode, a zener diode or a bandgap reference is provided for setting the reference voltage.

10. The circuit as claimed in claim 1, wherein the current mirror has two pnp transistors.

11. The circuit as claimed in claim 1, wherein the hysteresis circuit comprises at least one Schmitt trigger.

12. The circuit as claimed in claim 1, wherein the hysteresis circuit comprises at least one buffer.

13. A method for operating a circuit according to claim 1.

14. A luminaire comprising the circuit according to claim 1.
